(19) United States
(12) Patent Application Publication
(10) Pub. No.: US 2025/0147398 A1
(43) Pub. Date: May 8, 2025

(54) ILLUMINATION DEVICE AND PROJECTOR

(71) Applicant: SEIKO EPSON CORPORATION, Tokyo (JP)

(72) Inventor: Koichi AKIYAMA, AZUMINO-SHI (JP)

(21) Appl. No.: 18/938,452

(22) Filed: Nov. 6, 2024

(30) Foreign Application Priority Data
Nov. 6, 2023 (JP) 2023-189467

(51) Int. Cl. G03B 21/20; G03B 33/12

(52) U.S. Cl. CPC G03B 21/204; G03B 21/2013; G03B 21/2066; G03B 33/12

(57) ABSTRACT

An illumination device includes a first light source unit configured to emit first light in a first wavelength band, a second light source unit configured to emit second light in a second wavelength band different from the first wavelength band, a light combining element configured to combine the first light and the second light to emit composite light, a diffusion member configured to diffuse the composite light emitted from the light combining element, and a concave mirror configured to collect the composite light emitted from the light combining element to cause the composite light collected to enter the diffusion member.

The present application is based on, and claims priority from JP Application Serial Number 2023-189467, filed Nov. 6, 2023, the disclosure of which is hereby incorporated by reference herein in its entirety.

### BACKGROUND

### 1. Technical Field

The present disclosure relates to an illumination device and a projector.

### 2. Related Art

To enhance the performance of projectors, a projector including an illumination device using a laser source, which is a light source wide in color gamut and high in efficiency has been proposed. JP-A-2019-61110 described below discloses an illumination device including a light source device including a blue laser, a green laser, and a red laser, a light collection optical system that collects light emitted from the light source device, and a diffuser plate that diffuses the light emitted from the light collection optical system.

JP-A-2019-61110 is an example of the related art.

JP-A-2019-61110 discloses a configuration in which light beams emitted from the lasers of the respective colors are combined with each other to generate white composite light, and then the composite light is converged on the diffuser plate using a single condenser lens. However, in the configuration in which the composite light is converged using the single condenser lens, the spot size of the composite light on the diffuser plate becomes large. As a result, there arises a problem that the light use efficiency in the optical system at a posterior stage of the diffuser plate decreases.

### SUMMARY

In view of the problem described above, an illumination device according to one aspect of the present disclosure includes a first light source unit configured to emit first light in a first wavelength band, a second light source unit configured to emit second light in a second wavelength band different from the first wavelength band, a light combining element configured to combine the first light and the second light to emit composite light, a diffusion member configured to diffuse the composite light emitted from the light combining element, and a concave mirror configured to collect the composite light emitted from the light combining element to cause the composite light collected to enter the diffusion member.

A projector according to another aspect of the present disclosure includes the illumination device according to the aspect of the present disclosure, a light modulation device configured to modulate light containing the composite light output from the illumination device in accordance with image information, and a projection optical device configured to project the light modulated by the light modulation device.

### BRIEF DESCRIPTION OF THE DRAWINGS

FIG. 1 is a schematic configuration diagram of a projector according to a first embodiment.

FIG. 2 is a schematic configuration diagram of an illumination device according to the first embodiment.

FIG. 3 is a front view of a diffuser device.

FIG. 4 is a cross-sectional view of a diffuser plate along a line IV-IV in FIG. 3.

FIG. 5 is a schematic configuration diagram of an illumination device according to a second embodiment.

### DESCRIPTION OF EMBODIMENTS

### First Embodiment

A first embodiment of the present disclosure will hereinafter be described using the drawings.

A projector according to the present embodiment is an example of a liquid crystal projector including an illumination device using laser diodes.

Note that in the following drawings, elements are drawn at different dimensional scales in some cases in order to make the elements eye-friendly.

A projector 10 according to the present embodiment is a projection-type image display apparatus that displays a color image on a screen (projection target surface) SCR. The projector 10 includes three light modulation devices corresponding respectively to three colored light beams, namely red light LR, green light LG, and blue light LB. The projector 10 includes the laser diodes each capable of generating high-luminance and high-power light as light emitting elements of a light source device.

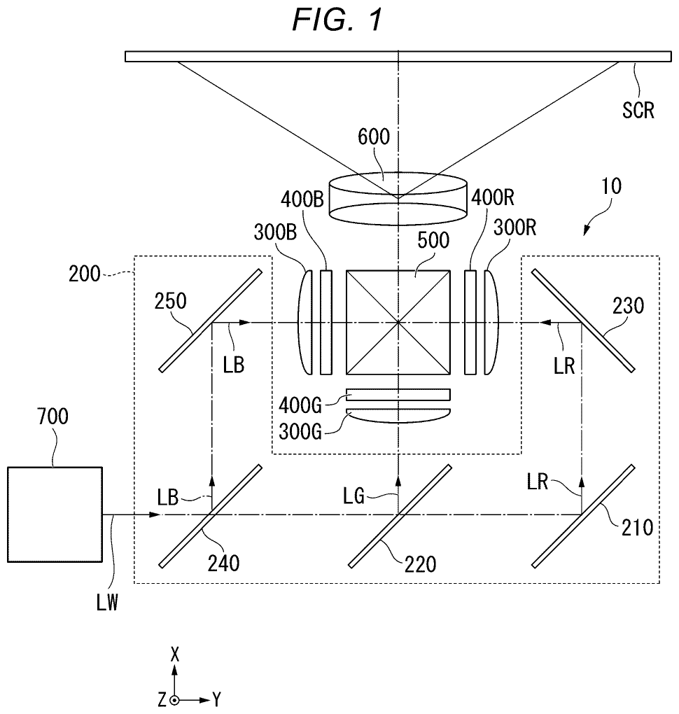

FIG. 1 is a schematic configuration diagram of the projector 10 according to the present embodiment.

As shown in FIG. 1, the projector 10 includes an illumination device 700, a color-separation light-guide optical system 200, a red-light light modulation device 400R, a green-light light modulation device 400G, a blue-light light modulation device 400B, a combining optical system 500, and a projection optical device 600. The red-light light modulation device 400R, the green-light light modulation device 400G, and the blue-light light modulation device 400B modulate light containing composite light LW emitted from the illumination device 700 in accordance with image information to thereby form image light. The projection optical device 600 projects the image light onto the screen SCR (projection target surface).

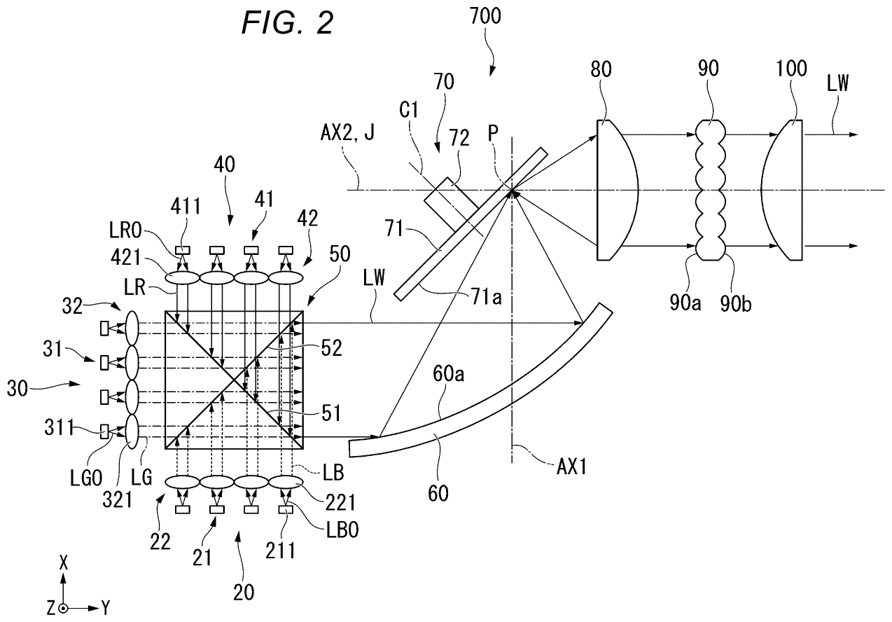

FIG. 2 is a schematic configuration diagram of the illumination device 700.

As illustrated in FIG. 2, the illumination device 700 includes a blue light source unit 20, a green light source unit 30, a red light source unit 40, a light combining element 50, a concave mirror 60, a diffusion device 70, a collimator optical system 80, a double-sided multi-lens array 90, and a superimposing lens 100.

In the following description, an axis along an emission direction of each of the color light beams LB, LR from the blue light source unit 20 and the red light source unit 40 is defined as an X axis, an axis along the emission direction of the composite light LW from the illumination device 700 is defined as a Y axis, and an axis perpendicular to the X axis and the Y axis is defined as a Z axis. Further, an axis that passes through a light focus point P on a diffusing surface 71a of a diffuser plate 71 and is parallel to the X axis is defined as an optical axis AX1, and an axis (a central axis of the composite light LW emitted from the diffuser plate 71) that passes through the light focus point P on the diffusing surface and is parallel to the Y axis is defined as an optical axis AX2.

The blue light source unit 20 includes a blue laser diode array 21 and a first collimator lens array 22. The blue light source unit 20 in the present embodiment corresponds to a first light source unit in the appended claims.

The blue laser diode array 21 includes a plurality of blue laser diodes 211 arranged in an array. The blue laser diodes 211 emit blue beams LB0 in a first wavelength band in the +X direction. The first wavelength band is, for example, 455 nm+10 nm. The number and the arrangement of the blue laser diodes 211 are not particularly limited.

The first collimator lens array 22 is disposed at the light exit side of the blue laser diode array 21. The first collimator lens array 22 includes a plurality of collimator 221 provided so as to correspond respectively to the plurality of blue laser diodes 211. The collimator lens 221 is configured with a convex lens. The collimator lens 221 collimates the blue beam LB0 emitted from the blue laser diode 211. The plurality of blue beams LB0 output from the first collimator lens array 22 is hereinafter collectively referred to as the blue light LB. Accordingly, the blue light LB is parallel light collimated by the first collimator lens array 22. The blue light LB in the present embodiment corresponds to first light in the appended claims.

The green light source unit 30 includes a green laser diode array 31 and a second collimator lens array 32. The green light source unit 30 in the present embodiment corresponds to a second light source unit in the appended claims.

The green laser diode array 31 includes a plurality of green laser diodes 311 arranged in an array. The green laser diodes 311 emit green beams LG0 in a second wavelength band in the +Y direction. The second wavelength band is, for example, 535 nm+10 nm. The number and the arrangement of the green laser diodes 311 are not particularly limited.

The second collimator lens array 32 is disposed at the light exit side of the green laser diode array 31. The second collimator lens array 32 includes a plurality of collimator 321 provided so as to correspond respectively to the plurality of green laser diodes 311. The collimator lens 321 is configured with a convex lens. The collimator lens 321 collimates the green beam LG0 emitted from the green laser diode 311. The plurality of green beams LG0 emitted from the second collimator lens array 32 is hereinafter collectively referred to as the green light LG. Accordingly, the green light LG is parallel light collimated by the second collimator lens array 32. The green light LG in the present embodiment corresponds to second light in the appended claims.

The red light source unit 40 includes a red laser diode array 41 and a third collimator lens array 42. The red light source unit 40 in the present embodiment corresponds to a third light source unit in the appended claims.

The red laser diode array 41 includes a plurality of red laser diodes 411 arranged in an array. The red laser diodes 411 emit red beams LR0 in a third wavelength band in the −X direction. The third wavelength band is, for example, 640 nm+10 nm. The number and the arrangement of the red laser diodes 411 are not particularly limited.

The third collimator lens array 42 is disposed at the light exit side of the red laser diode array 41. The third collimator lens array 42 includes a plurality of collimator lenses 421 provided so as to correspond respectively to the plurality of red laser diodes 411. The collimator lens 421 is configured with a convex lens. The collimator lens 421 collimates the red beam LR0 emitted from the red laser diode 411. The plurality of red beams LR0 emitted from the third collimator lens array 42 is hereinafter collectively referred to as the red light LR. Accordingly, the red light LR is parallel light collimated by the third collimator lens array 42. The red light LR in the present embodiment corresponds to third light in the appended claims.

The light combining element 50 is configured with a cross dichroic prism. The cross dichroic prism includes a first dichroic mirror 51 and a second dichroic mirror 52. The first dichroic mirror 51 reflects the red light LR and transmits the green light LG and the blue light LB. The second dichroic mirror 52 reflects the blue light LB and transmits the green light LG and the red light LR. Accordingly, the light combining element 50 combines the blue light LB emitted from the blue light source unit 20, the green light LG emitted from the green light source unit 30, and the red light LR emitted from the red light source unit 40 with each other to emit the white composite light LW toward the concave mirror 60. Since the light emitted from each of the laser diodes is linearly-polarized light, the composite light LW emitted from the light combining element 50 is also linearly-polarized light.

The concave mirror 60 is provided at the light exit side (+Y side) of the light combining element 50. The concave mirror 60 includes a reflecting surface 60a that reflects the composite light LW emitted from the light combining element 50. The concave mirror 60 is configured with an off-axis parabolic mirror. The off-axis parabolic mirror is a mirror in which a reflecting surface is formed of a part of a parabolic surface and the reflecting surface is configured so as not to cross the central axis (optical axis) of the parabolic surface. In other words, the off-axis parabolic mirror has a shape obtained by leaving a part not including the central axis of the parabolic surface, and cutting the rest of the parabolic surface. Therefore, an optical axis J of the concave mirror 60 is located at a position not crossing the reflecting surface 60a, and is located outside the incident range of the composite light LW on the concave mirror 60. The concave mirror 60 collects the composite light LW emitted from the light combining element 50 while reflecting the composite light LW, and then makes the composite light LW thus collected enter the diffuser plate 71 described later. The specific configuration of the concave mirror 60 is not particularly limited. In FIG. 2, the optical axis J of the concave mirror 60 coincides with the optical axis AX2.

As described above, since the colored light beams LB, LG, and LR incident on the light combining element 50 are parallel light beams collimated by the respective collimator lens arrays 22, 32, and 42, the composite light LW incident on the concave mirror 60 from the light combining element 50 is also parallel light. Further, since the orientation of the concave mirror 60 with respect to the light combining element 50 is appropriately set, the central axis of the composite light LW incident on the concave mirror 60 and the optical axis J of the concave mirror 60 are parallel to each other. From the characteristics of the off-axis parabolic mirror, when two conditions, namely a condition that the light incident on the off-axis parabolic mirror is parallel light and a condition that the central axis (an axis parallel to the incident direction) of the incident light and the optical axis of the off-axis parabolic mirror are parallel to each other, are satisfied, the light reflected by the off-axis parabolic mirror is converged on one point (focal point) on the optical axis of the off-axis parabolic mirror. Therefore, according to the present embodiment, the composite light LW reflected by the concave mirror 60 is converged on one point on the optical axis J of the concave mirror 60. Note that in this specification, the description that one axis and another axis are parallel to each other includes not only when the one axis and the other axis are completely parallel to each other but also when the one axis and the other axis form an angle within +5°.

The diffusion device 70 includes the diffuser plate 71 shaped like a disk and a drive device 72. The diffuser plate 71 includes the diffusing surface 71a that diffusely reflects the composite light LW emitted from the concave mirror 60. That is, the diffuser plate 71 in the present embodiment is not a transmissive diffuser plate but is a reflective diffuser plate. The diffuser plate 71 is disposed at a position where the diffusing surface 71a crosses each of the optical axis AX1 and the optical axis AX2. Further, the diffusing surface 71a of the diffuser plate 71 is disposed at the light focus point P of the composite light LW reflected by the concave mirror 60. In other words, the focal point of the concave mirror 60 is located on the diffusing surface 71a of the diffuser plate 71. Further, the central axis of the composite light LW emitted from the diffuser plate 71 is parallel to the optical axis J of the concave mirror 60.

The drive device 72 is configured with a motor, and rotates the diffuser plate 71 around a rotational axis C1, which crosses the diffusing surface 71a. By rotating the diffuser plate 71, speckle noise that is apt to occur when using a laser diode can be reduced. Note that the diffusing surface 71a in the present specification does not mean a curved surface formed of a shape of a fine uneven structure described later, but means a single surface on which a plurality of recesses and a plurality of protrusions are substantially arranged. The diffuser plate 71 in the present embodiment corresponds to a diffusion member in the appended claims.

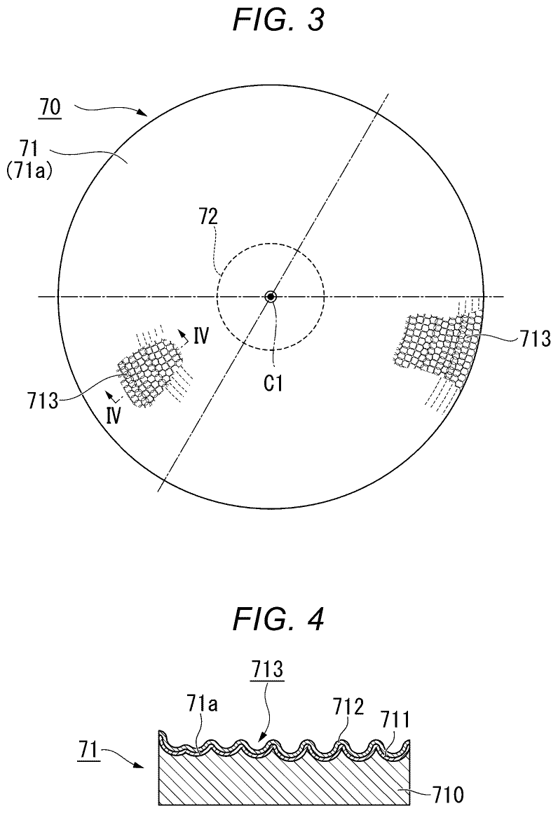

FIG. 3 is a front view of the diffusion device 70. FIG. 4 is a cross-sectional view of the diffuser plate 71 along a line IV-IV in FIG. 3.

As shown in FIG. 3 and FIG. 4, the diffuser plate 71 includes a light transmissive substrate 710, a metal reflective film 711, and a dielectric multilayer film 712.

The light transmissive substrate 710 is made of, for example, optical glass such as BK7. Out of the two surfaces of the light transmissive substrate 710, the diffusing surface 71a, on which the composite light LW is incident, is provided with an uneven structure 713 configured with the plurality of recesses and the plurality of protrusions. The uneven structure 713 has a plurality of curved surfaces arranged randomly. That is, the light transmissive substrate 710 has the uneven structure 713 including the plurality of recesses and the plurality of protrusions. The recesses are each formed in a substantially spherical shape. The depth of each of the recesses is, for example, about a quarter of the diameter of the spherical surface. The uneven structure 713 can be formed by a method of scraping the light transmissive substrate 710 with etching processing or the like, plastically deforming the light transmissive substrate 710 with blasting processing, or the like.

The metal reflective film 711 is disposed along the uneven structure 713 of the light transmissive substrate 710. The metal reflective film 711 is formed of, for example, a material containing aluminum. Specifically, the metal reflective film 711 is made of high-purity aluminum having an aluminum content no lower than 99.99 wt %. Preferably, as the metal reflective film 711, ultra-high-purity aluminum having an aluminum content no lower than 99.999 wt % can be selected.

The metal reflective film 711 can be obtained by forming a pure aluminum film having a predetermined film thickness and a smooth surface on the diffusing surface 71a of the light transmissive substrate 710 using a film formation method such as sputtering or vapor deposition. In a film formation step, when using a sputtering target having an aluminum content of, for example, 99.999 wt %, the metal reflective film 711 made of ultra-high-purity aluminum having the aluminum content of 99.999 wt % can be obtained.

The dielectric multilayer film 712 is disposed on a surface of the metal reflective film 711 at an opposite side to the light transmissive substrate 710. That is, the diffuser plate 71 has a configuration in which the metal reflective film 711 and the dielectric multilayer film 712 are stacked in this order on the light transmissive substrate 710. Although not shown in FIG. 4, the dielectric multilayer film 712 has a configuration in which two types of dielectric films different in refractive index from each other are alternately stacked on one another a plurality of times.

In the diffuser plate 71 in the present embodiment, the uneven structure 713 reflects once the composite light LW emitted from the concave mirror 60 to emit the composite light LW toward the collimator optical system 80. Accordingly, the composite light LW emitted from the concave mirror 60 is emitted from the diffuser plate 71 toward the collimator optical system 80 without being multiply reflected by the diffusing surface 71a. According to this configuration, since the composite light LW emitted from the concave mirror 60 is not multiply reflected by the diffusing surface 71a, disturbance of the polarization direction of the composite light LW can be suppressed. Note that the diffuser plate 71 may be a microlens-array type diffuser plate including a microlens array.

Note that instead of the configuration shown in FIG. 4, the diffuser plate 71 may not be provided with the metal reflective film 711, but the dielectric multilayer film 712 may be directly formed on the uneven structure 713 of the light transmissive substrate 710. According to this configuration, it is possible to simplify the manufacturing step of the diffuser plate. However, in the case of the configuration provided with the metal reflective film 711, since the reflection function can be played by both the metal reflective film 711 and the dielectric multilayer film 712, the number of layers in the dielectric multilayer film 712 can be reduced.

Alternatively, the diffuser plate 71 may be configured with a metal substrate and the dielectric multilayer film 712. As the metal substrate, for example, an aluminum alloy can be used. As the aluminum alloy, there is used, for example, an Al—Mg—Si based alloy obtained by adding magnesium (Mg) and silicon (Si) to aluminum (Al). Besides the above, the aluminum alloy may contain element such as iron (Fe), copper (Cu), manganese (Mn), chromium (Cr), zinc (Zn), or titanium (Ti). In this case, it is sufficient to form an uneven structure on one surface of the metal substrate by performing the blasting processing on the metal substrate, and then form the dielectric multilayer film 712 on the uneven structure. According to this configuration, it is possible to simplify the configuration of the diffuser plate.

As shown in FIG. 2, the collimator optical system 80 is disposed at the light exit side of the diffuser plate 71 on the optical axis AX2. The collimator optical system 80 is formed of a convex lens. The collimator optical system 80 collimates the composite light LW emitted from the diffuser plate 71 at a predetermined diffusion angle, and then emits the composite light LW toward the double-sided multi-lens array 90.

The double-sided multi-lens array 90 and the superimposing lens 100 configure an integrator optical system. The integrator optical system homogenizes the illuminance distribution of the composite light LW emitted from the collimator optical system 80 in the image formation region of each of the red-light light modulation device 400R, the green-light light modulation device 400G, and the blue-light light modulation device 400B.

The double-sided multi-lens array 90 is disposed at the light exit side of the collimator optical system 80 on the optical axis AX2. The double-sided multi-lens array 90 is a multi-lens array obtained by integrating a first multi-lens surface 90a and a second multi-lens surface 90b into a single member. The first multi-lens surface 90a includes a plurality of lenses for dividing the composite light LW emitted from the collimator optical system 80 into a plurality of partial light beams. The plurality of lenses is arranged in a matrix in a plane perpendicular to the optical axis AX2. The double-sided multi-lens array 90 in the present embodiment corresponds to a multi-lens optical system in the appended claims.

The second multi-lens surface 90b includes a plurality of lenses corresponding to the plurality of lenses on the first multi-lens surface 90a. Along with the superimposing lens 100 in the posterior stage, the second multi-lens surface 90b forms images of the lenses on the first multi-lens surface 90a in the image formation region or the vicinity thereof in each of the red-light light modulation device 400R, the green-light light modulation device 400G, and the blue-light light modulation device 400B. The plurality of lenses is arranged in a matrix in a plane perpendicular to the optical axis AX2. Note that the first multi-lens surface 90a and the second multi-lens surface 90b may be separately provided as two multi-lens arrays. Further, a drive device that vibrates or swings the double-sided multi-lens array 90 in a direction (direction along the X-Z plane) perpendicular to the optical axis AX2 may be provided. Vibrating or swinging the double-sided multi-lens array 90 makes it possible to reduce the speckle noise which is apt to occur when using the laser diode.

The superimposing lens 100 collects each of the plurality of partial light beams emitted from the double-sided multi-lens array 90 and superimposes the partial light beams on one another in the image formation region or the vicinity thereof in each of the red-light light modulation device 400R, the green-light light modulation device 400G, and the blue-light light modulation device 400B.

As shown in FIG. 1, the color-separation light-guide optical system 200 includes dichroic mirrors 240, 220 and reflection mirrors 210, 230, and 250. The color-separation light-guide optical system 200 separates the white composite light LW output from the illumination device 700 into the red light LR, the green light LG, and the blue light LB, and guides the red light LR, the green light LG, and the blue light LB to the red-light light modulation device 400R, the green-light light modulation device 400G, and the blue-light light modulation device 400B corresponding respectively thereto.

A field lens 300R is disposed between the color-separation light-guide optical system 200 and the red-light light modulation device 400R. A field lens 300G is disposed between the color-separation light-guide optical system 200 and the green-light light modulation device 400G. A field lens 300B is disposed between the color-separation light-guide optical system 200 and the blue-light light modulation device 400B.

The dichroic mirror 240 reflects the blue light LB and transmits the red light LR and the green light LG. The dichroic mirror 220 reflects the green light LG and transmits the red light LR. The reflection mirrors 210, 230 each reflect the red light LR. The reflection mirror 250 reflects the blue light LB.

The red-light light modulation device 400R is configured with a liquid crystal panel that modulates the red light LR in accordance with the image information to form an image. The green-light light modulation device 400G is configured with a liquid crystal panel that modulates the green light LG in accordance with the image information to form an image. The blue-light light modulation device 400B is configured with a liquid crystal panel that modulates the blue light LB in accordance with the image information to form an image.

Although not shown in the drawings, incident-side polarization platers are disposed between the field lens 300R and the red-light light modulation device 400R, between the field lens 300G and the green-light light modulation device 400G, and between the field lens 300B and the blue-light light modulation device 400B, respectively. Exit-side polarization plates are disposed between the red-light light modulation device 400R and the combining optical system 500, between the green-light light modulation device 400G and the combining optical system 500, and between the blue-light light modulation device 400B and the combining optical system 500, respectively. Note that the incident-side polarization plates are not required to be provided when the polarization disturbance in the polarized light emitted from the illumination device 700 caused by the optical system in the posterior stage of the illumination device 700 is acceptable.

The combining optical system 500 combines the image light emitted from the red-light light modulation device 400R, the image light emitted from the green-light light modulation device 400G, and the image light emitted from the blue-light light modulation device 400B with each another. The combining optical system 500 is configured with a cross dichroic prism formed by bonding four rectangular prisms to each other to have a substantially square shape in a plan view. In the cross dichroic prism, dielectric multilayer films are disposed on the interfaces having a substantially X shape formed by bonding the rectangular prisms to each other.

The image light emitted from the combining optical system 500 is projected on the screen SCR in an enlarged manner by the projection optical device 600. The projection optical device 600 is configured with a plurality of lenses.

### Advantages of First Embodiment

The illumination device 700 according to the present embodiment includes the blue light source unit 20 that emits the blue light LB, the green light source unit 30 that emits the green light LG, the red light source unit 40 that emits the red light LR, the light combining element 50 that combines the blue light LB, the green light LG, and the red light LR with each other to emit the composite light LW, the diffuser plate 71 that diffuses the composite light LW emitted from the light combining element 50, and the concave mirror 60 that condenses the composite light LW emitted from the light combining element 50 to cause the composite light LW thus condensed to enter the diffuser plate 71. Further, the concave mirror 60 is formed of the off-axis parabolic mirror.

In the related-art configuration in which white composite light is converged on a diffuser plate using a single condenser lens, since a glass material forming the condenser lens has wavelength dispersion, a substantial refractive index differs depending on a wavelength of the light, and as a result, chromatic aberration cannot be avoided. Therefore, when specific colored light is focused, blurring occurs in other colored light, and a spot of the composite light on the diffuser plate becomes large as a whole. As a result, the image on an exit-side multi-lens array in the posterior stage of the diffuser plate, that is, the secondary light source image, becomes large to increase the etendue. This causes a problem that the light use efficiency in the optical system in the posterior stage decreases. Further, in order to suppress the decrease in light use efficiency as much as possible, it is necessary to increase the positional accuracy of optical components such as a multi-lens array and a laser diode in the posterior stage of the diffuser plate, which increases the load of the assembly step of the illumination device. It is possible to correct the chromatic aberration by using a combination lens including a convex lens and a concave lens in a light collection optical system, but in this case, there is a possibility that the growth in size of the illumination device and an increase in cost are incurred.

To cope with the problem described above, according to the illumination device 700 in the present embodiment, since the concave mirror 60 is used instead of the related-art lens as a light collection device to the diffuser plate 71, the chromatic aberration does not occur in principle. Further, since the concave mirror 60 is configured with the off-axis parabolic mirror, spherical aberration does not occur in principle when using a spherical mirror. As described above, the composite light LW reflected by the concave mirror 60 is focused on the one point on the optical axis J of the concave mirror 60, that is, the one point on the diffuser plate 71. Further, when using the concave mirror 60 formed of the off-axis parabolic mirror, it is possible to shorten the focal distance compared to when using a lens.

In view of the above, according to the illumination device 700 in the present embodiment, the spot size of the composite light LW on the diffuser plate 71 can be made smaller compared to that in the related-art illumination device. Accordingly, since the secondary light source image formed on the second multi-lens surface 90b of the double-sided multi-lens array 90 can be made smaller, the illumination device 700 small in etendue and excellent in light use efficiency can be realized. Further, since the secondary light source image can be made smaller, the positional accuracy of the optical components such as the double-sided multi-lens array 90 and the laser diodes 211, 311, and 411 can be relaxed, and the load of the assembly step of the illumination device 700 can be reduced. Further, since it is not necessary to use a lens for correcting the chromatic aberration, it is possible to suppress an increase in size and cost of the illumination device 700.

In the case of the present embodiment, the off-axis parabolic mirror is used as the concave mirror 60, and the optical axis J of the concave mirror 60 does not cross the reflecting surface 60a and is located outside the incident range of the composite light LW. In other words, the concave mirror 60 obtained by keeping only a minimum necessary part which does not include the optical axis J out of the parabolic mirror, and cutting the rest of the parabolic mirror is used. Therefore, the optical components such as the diffuser plate 71 and the collimator optical system 80 are prevented from physically interfering with the concave mirror 60. This can suppress the loss of the composite light LW, and can achieve the reduction in size of the illumination device 700.

The projector 10 according to the present embodiment includes the illumination device 700 according to the present embodiment, the light modulation devices 400R, 400G, and 400B which modulate light containing the composite light LW emitted from the illumination device 700 in accordance with the image information, and the projection optical device 600 which projects the light modulated by the light modulation devices 400R, 400G, and 400B.

According to this configuration, the projector 10 excellent in light use efficiency can be realized.

### Second Embodiment

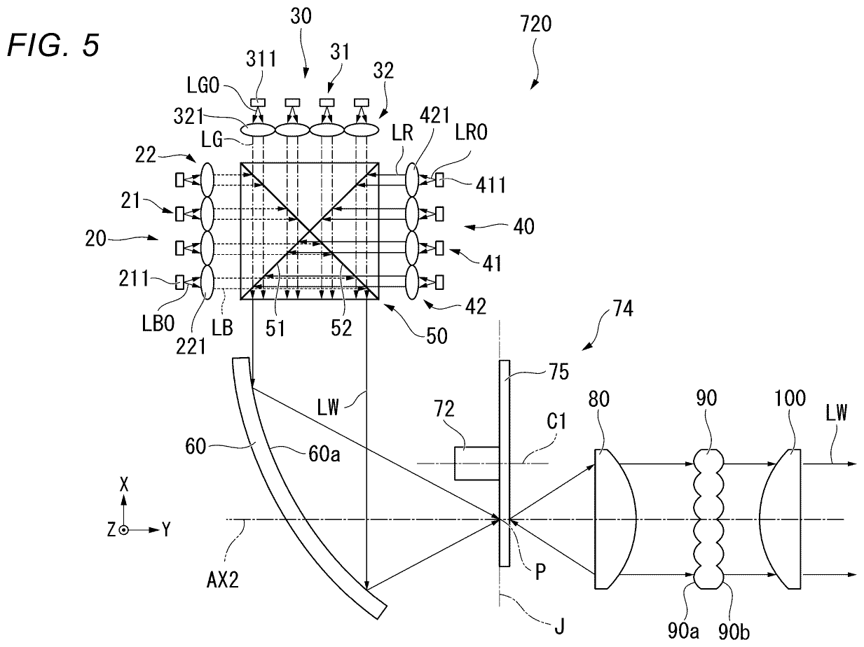

A second embodiment of the present disclosure will hereinafter be described using FIG. 5.

The basic configuration of a projector according to the second embodiment is substantially the same as in the first embodiment, but the configuration of the illumination device differs from that in the first embodiment. Therefore, the description of the basic configuration of the projector will be omitted.

FIG. 5 is a schematic configuration diagram of an illumination device 720 according to the second embodiment.

In FIG. 5, the elements common to those in FIG. 2 used in the description of the first embodiment will be denoted by the same reference symbols to omit the description thereof.

As illustrated in FIG. 5, the illumination device 720 according to the present embodiment includes the blue light source unit 20, the green light source unit 30, the red light source unit 40, the light combining element 50, the concave mirror 60, a diffusion device 74, the collimator optical system 80, the double-sided multi-lens array 90, and the superimposing lens 100. The basic configuration of the illumination device 720 is substantially the same as that of the illumination device 700 according to the first embodiment, and the configuration of a diffuser plate 75 is different from that of the diffuser plate 71 in the first embodiment.

The diffuser plate 75 diffuses the composite light LW emitted from the concave mirror 60 while transmitting the composite light LW. That is, unlike the diffuser plate 71 in the first embodiment, the diffuser plate 75 in the present embodiment is a transmissive diffuser plate. The diffuser plate 75 may be formed of a light transmissive substrate provided with the uneven structure, or may be formed of a light transmissive substrate including a light scattering material. The diffuser plate 75 is disposed at the light focus point P of the composite light LW reflected by the concave mirror 60. In the case of the present embodiment, the light source units 20, 30, and 40 of the respective colors, the light combining element 50, and the concave mirror 60 are arranged in an orientation rotated clockwise by 90 degrees with respect to these members in the first embodiment, and the diffuser plate 75 is arranged in parallel to the optical axis J of the concave mirror 60. The rest of the configuration of the illumination device 720 is substantially the same as that of the illumination device 700 according to the first embodiment.

### Advantages of Second Embodiment

Also in this embodiment, since the spot size on the diffuser plate 75 can be made smaller compared to that of the related-art illumination device, substantially the same advantages of the first embodiment such as the advantage that the secondary light source image can be made smaller to thereby realize the illumination device 720 excellent in light use efficiency, the advantage that the positional accuracy of the optical components such as the double-sided multi-lens array 90 can be relaxed to thereby reduce the load of the assembling step of the illumination device 720, and the advantage that the increase in size and cost of the illumination device 720 can be suppressed since there is no need to use the lens for correcting the chromatic aberration can be obtained.

Note that the technical scope of the present disclosure is not limited to the embodiments described above, and a variety of changes can be made thereto without departing from the intent of the present disclosure.

The illumination device according to the embodiments described above includes the off-axis parabolic mirror as the light collection device to the diffuser plate, but may include a spherical mirror instead of the off-axis parabolic mirror. Also in this configuration, the chromatic aberration can be eliminated. Further, when there is no problem in the physical interference between the optical components or the degradation in the light use efficiency, a parabolic mirror having the optical axis at a position crossing the reflection surface may be used instead of the off-axis parabolic mirror. Further, although the illumination device according to each of the embodiments described above includes the rotary diffuser plate, the diffuser plate is not necessarily required to be rotatable, and may be of a stationary type.

Besides the above, the specific descriptions of the shapes, the numbers, the arrangements, the materials, and other factors of the elements of the illumination device and the projector are not limited to those in the embodiments described above and can be changed as appropriate. Further, the embodiments described above show the example in which the illumination device according to the present disclosure is incorporated in the projector using the liquid crystal panels, but this is not a limitation. The illumination device according to the present disclosure may be applied to a projector using digital micromirror devices as the light modulation devices. Further, the projector is not required to include the plurality of light modulation devices and may be a single-panel projector including only a single light modulation device.

The embodiments described above show the example in which the illumination device according to the present disclosure is applied to the projector, but this is not a limitation. The illumination device according to the present disclosure may be applied to lighting equipment, a headlight of an automobile, and so on.

### Summary of Present Disclosure

The present disclosure will be summarized below as additional remarks.

### Additional Remark 1

An illumination device including
a first light source unit configured to emit first light in a first wavelength band,
a second light source unit configured to emit second light in a second wavelength band different from the first wavelength band,
a light combining element configured to combine the first light and the second light to emit composite light,
a diffusion member configured to diffuse the composite light emitted from the light combining element, and
a concave mirror configured to collect the composite light emitted from the light combining element to cause the composite light collected to enter the diffusion member.

According to the configuration of Additional Remark 1, since the concave mirror is used as a light collection device to the diffusion member, it is possible to realize the illumination device which does not generate the chromatic aberration and is excellent in the light use efficiency.

### Additional Remark 2

The illumination device described in Additional Remark 1, wherein the concave mirror is an off-axis parabolic mirror.

According to the configuration of Additional Remark 2, occurrence of spherical aberration can be suppressed in addition to the chromatic aberration. Further, since the physical interference between the optical component such as the diffusion member and the concave mirror is avoided, the loss of the composite light can be suppressed, and the reduction in size of the illumination device can be achieved.

### Additional Remark 3

The illumination device described in Additional Remark 1 or Additional Remark 2, wherein the composite light incident on the off-axis parabolic mirror is parallel light, and a central axis of the composite light incident on the off-axis parabolic mirror and an optical axis of the off-axis parabolic mirror are parallel to each other.

According to the configuration in Additional Remark 3, it is possible to focus the composite light reflected by the off-axis parabolic mirror on the focal point on the optical axis of the off-axis parabolic mirror. Accordingly, the light use efficiency can sufficiently be increased.

### Additional Remark 4

The illumination device described in Additional Remark 3, wherein the optical axis of the off-axis parabolic mirror is located outside an incident range of the composite light on the off-axis parabolic mirror.

According to the configuration of Additional Remark 4, it is possible to reliably avoid the physical interference between the optical component such as the diffusion member and the off-axis parabolic mirror.

### Additional Remark 5

The illumination device described in Additional Remark 3 or Additional Remark 4, wherein a focal point of the off-axis parabolic mirror is located on a diffusing surface of the diffusion member.

According to the configuration of Additional Remark 5, the composite light reflected by the off-axis parabolic mirror can be focused on the diffusing surface of the diffusion member. Accordingly, the spot size of the composite light on the diffusing surface can be minimized, and the light use efficiency can sufficiently be increased.

### Additional Remark 6

The illumination device described in Additional Remark 4 or Additional Remark 5, wherein the diffusion member is a reflective diffusion member configured to diffusely reflect the composite light, and
a central axis of the composite light emitted from the diffusion member is parallel to the optical axis of the off-axis parabolic mirror.

According to the configuration of Additional Remark 6, the loss caused by light scattering can be reduced to increase the light use efficiency compared to when using the transmissive diffusion member. Further, the diffusion member and the off-axis parabolic mirror can be efficiently arranged, and the reduction in size of the illumination device can be achieved.

### Additional Remark 7

The illumination device described in any one of Additional Remark 1 to Additional Remark 6, further including a third light source unit configured to emit third light in a third wavelength band different from the first wavelength band and the second wavelength band, wherein
the light combining element is configured to combine the first light, the second light, and the third light, and
the first wavelength band is a blue wavelength band, the second wavelength band is a green wavelength band, and the third wavelength band is a red wavelength band.

According to the configuration of Additional Remark 7, it is possible to realize the illumination device configured to emit white composite light.

### Additional Remark 8

The illumination device described in Additional Remark 7, wherein each of the first light source unit, the second light source unit, and the third light source unit includes a laser diode.

According to the configuration of Additional Remark 8, it is possible to realize the illumination device that is wide in color gamut and high in efficiency and can emit linearly polarized light.

### Additional Remark 9

The illumination device described in Additional Remark 8, further including a drive device configured to rotate the diffusion member around a rotational axis crossing the diffusing surface.

According to the configuration of Additional Remark 9, the speckle noise caused by using the laser diode can be reduced.

### Additional Remark 10

The illumination device described in any one of Additional Remark 1 to Additional Remark 9, further including
a collimator optical system configured to collimate the composite light emitted from the diffusion member,
a multi-lens optical system configured to divide the composite light emitted from the collimator optical system into a plurality of partial light beams, and
a superimposing lens configured to superimpose the plurality of partial light beams emitted from the multi-lens optical system on an illumination target surface.

According to the configuration of Additional Remark 10, it is possible to reduce the secondary light source image on the exit-side multi-lens surface of the multi-lens optical system, and it is possible to realize the illumination device excellent in light use efficiency.

### Additional Remark 11

A projector including
the illumination device described in any one of Additional Remark 1 to Additional Remark 10,
a light modulation device configured to modulate light containing the composite light emitted from the illumination device in accordance with image information, and
a projection optical device configured to project the light modulated by the light modulation device.

According to the configuration in Additional Remark 11, the projector high in light use efficiency can be realized.

What is claimed is:

1. An illumination device comprising:
a first light source unit configured to emit first light in a first wavelength band;
a second light source unit configured to emit second light in a second wavelength band different from the first wavelength band;
a light combining element configured to combine the first light and the second light to emit composite light;
a diffusion member configured to diffuse the composite light emitted from the light combining element; and
a concave mirror configured to collect the composite light emitted from the light combining element to cause the composite light collected to enter the diffusion member.

2. The illumination device according to claim 1, wherein
the concave mirror is an off-axis parabolic mirror.

3. The illumination device according to claim 1, wherein
the composite light incident on the off-axis parabolic mirror is parallel light, and a central axis of the composite light incident on the off-axis parabolic mirror and an optical axis of the off-axis parabolic mirror are parallel to each other.

4. The illumination device according to claim 3, wherein
the optical axis of the off-axis parabolic mirror is located outside an incident range of the composite light on the off-axis parabolic mirror.

5. The illumination device according to claim 3, wherein
a focal point of the off-axis parabolic mirror is located on a diffusing surface of the diffusion member.

6. The illumination device according to claim 4, wherein
the diffusion member is a reflective diffusion member configured to diffusely reflect the composite light, and
a central axis of the composite light emitted from the diffusion member is parallel to the optical axis of the off-axis parabolic mirror.

7. The illumination device according to claim 1, further comprising:
a third light source unit configured to emit third light in a third wavelength band different from the first wavelength band and the second wavelength band, wherein
the light combining element is configured to combine the first light, the second light, and the third light, and
the first wavelength band is a blue wavelength band, the second wavelength band is a green wavelength band, and the third wavelength band is a red wavelength band.

8. The illumination device according to claim 7, wherein
each of the first light source unit, the second light source unit, and the third light source unit includes a laser diode.

9. The illumination device according to claim 8, further comprising:
a drive device configured to rotate the diffusion member around a rotational axis crossing the diffusing surface.

10. The illumination device according to claim 1, further comprising:
a collimator optical system configured to collimate the composite light emitted from the diffusion member;
a multi-lens optical system configured to divide the composite light emitted from the collimator optical system into a plurality of partial light beams; and
a superimposing lens configured to superimpose the plurality of partial light beams emitted from the multi-lens optical system on an illumination target surface.

11. A projector comprising:
the illumination device according to claim 1;
a light modulation device configured to modulate light containing the composite light output from the illumination device in accordance with image information; and
a projection optical device configured to project the light modulated by the light modulation device.
